(19) United States
(12) Patent Application Publication
(10) Pub. No.: US 2014/0210836 A1
(43) Pub. Date: Jul. 31, 2014

(54) LAYER FOR REDUCED CHARGE MIGRATION BETWEEN MEMS LAYERS

(71) Applicant: QUALCOMM MEMS TECHNOLOGIES, INC., San Diego, CA (US)

(72) Inventors: Fan Zhong, Fremont, CA (US); Guneet Sethi, Fremont, CA (US); Daniel Felnhofer, San Jose, CA (US); Thanh N. Tu, San Jose, CA (US)

(73) Assignee: QUALCOMM MEMS TECHNOLOGIES, INC., San Diego, CA (US)

(21) Appl. No.: 13/751,785

(22) Filed: Jan. 28, 2013

(51) Int. Cl. G02B 26/00; G09G 3/20

(52) U.S. Cl. CPC G02B 26/002; G09G 3/20
USPC 345/530; 427/77; 427/78; 427/569; 359/290

(57) ABSTRACT

This disclosure provides systems, methods and apparatus for reducing image artifacts that arise when a display is exposed to sunlight over time. Various implementations disclosed herein can be implemented to prevent charge injection from inducing a negative offset voltage shift for display elements in the display. In one aspect, a buffer layer is applied to block electrons from being photoelectrically ejected from a movable reflective layer of a display element and into a stationary optical stack of the display element.

### TECHNICAL FIELD

This disclosure relates to electromechanical systems and devices, and in particular, to systems and methods for improving the reliability and robustness of electromechanical display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

Each IMOD display element may be associated with an actuation voltage, which causes the two conductive plates to move toward one another when the actuation voltage is applied across the two plates. The actuation voltage for a particular display element may be based on various factors, including the geometry, structure, and/or materials that form the display element. In particular, each display element can be calibrated to display a particular color when the actuation voltage is applied across the two plates. When a display element becomes uncalibrated, or out-of-tune, unwanted actuations or unwanted releases of the display element may occur, which can introduce undesirable image artifacts into an image to be displayed. Accordingly, it can be important to ensure that display elements remain calibrated under various operating conditions and parameters.

### SUMMARY

The systems, methods and devices of this disclosure each have several innovative aspects, no single one of which is solely responsible for the desirable attributes disclosed herein.

One innovative aspect of the subject matter described in this disclosure can be implemented in an electromechanical display element having an actuated state and a relaxed state. The electromechanical display element can include a fixed optical element having a dielectric layer applied over a transparent or semi-transparent conductive layer, and a movable reflective element having a reflective conductive layer applied over a buffer dielectric layer. A gap can be defined by the dielectric layer and the buffer dielectric layer when the electromechanical display element is in the relaxed state. The buffer dielectric layer can be proximate the dielectric layer when the electromechanical display element is in the actuated state. A thickness of the buffer dielectric layer can be selected such that, in the actuated state, electrons that are photoelectrically ejected from the reflective conductive layer are substantially prevented from being injected into the dielectric layer from the reflective conductive layer.

In some implementations, the buffer dielectric layer can have a thickness in a range of about 50 Å to about 300 Å. Further, the electromechanical display element can be configured to actuate from the relaxed state to the actuated state when an actuation voltage is applied across the transparent or semi-transparent conductive layer and the reflective conductive layer. The thickness of the buffer dielectric layer can be further selected such that the actuation voltage is substantially independent of the thickness of the buffer dielectric layer. In some arrangements, the thickness of the buffer dielectric layer can be selected such that, in the actuated state, electrons in the reflective conductive layer that are excited by photons having energies in a range of about 1.6 eV to about 3.6 eV are substantially prevented from being injected into the dielectric layer from the reflective conductive layer.

Another innovative aspect of the subject matter described in this disclosure can be implemented in a method for manufacturing one or more electromechanical display elements having an actuated state and a relaxed state. The method can comprise applying a transparent or semi-transparent conductive layer on a base layer, and applying a dielectric layer over the transparent or semi-transparent conductive layer. A sacrificial layer can be applied over the dielectric layer, and a buffer dielectric layer can be applied over the sacrificial layer. The method can further include applying a reflective conductive layer over the buffer dielectric layer, and removing the sacrificial material to define a gap between the dielectric layer and the buffer dielectric layer. A thickness of the buffer dielectric layer can be selected such that, upon actuation to move the dielectric layer to be proximate the buffer dielectric layer, electrons that are photoelectrically ejected from the reflective conductive layer are substantially prevented from being injected into the dielectric layer from the reflective conductive layer.

In some implementations, the method can include applying a first dielectric layer under the buffer dielectric layer and applying a second dielectric layer over the dielectric layer. Further, in some implementations, applying the sacrificial layer includes applying amorphous silicon.

Another innovative aspect of the subject matter described in this disclosure can be implemented in a display apparatus. The display apparatus can include a plurality of electromechanical display elements. Each electromechanical display element can have an actuated state and a relaxed state. The electromechanical display element can include a movable reflective element. The electromechanical display element can further include a fixed optical element, wherein a gap can be defined by the movable reflective element and the fixed optical element when the electromechanical display element is in the relaxed state. The movable reflective element can be proximate the fixed optical element when the electromechanical display element is in the actuated state. The movable reflective element can include means for preventing electrons that are photoelectrically ejected from the movable reflective element from being injected into the fixed optical element when the electromechanical display element is in the actuated state.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIGS. 2A-2E are cross-sectional illustrations of varying implementations of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIG. 5A is a schematic cross-sectional illustration of an unreleased IMOD display element.

FIG. 5B is a schematic cross-sectional illustration of a released IMOD display element in a relaxed state.

FIG. 5C is a schematic cross-sectional illustration of a released IMOD display element in an actuated state.

FIG. 6 is a set of graphs illustrating offset voltage shifts that may be induced when IMOD display elements are exposed to excessive amounts of sunlight.

FIG. 7A is a schematic cross-sectional illustration of an example unreleased IMOD display element, according to one implementation.

FIG. 7B is a schematic cross-sectional illustration of the IMOD display element of FIG. 7A in a released and actuated state.

FIG. 8A is a schematic cross-sectional illustration of an example unreleased IMOD display element, according to another implementation.

FIG. 8B is a schematic cross-sectional illustration of the IMOD display element of FIG. 8A in a released and actuated state.

FIG. 8C is a micrograph of an IMOD display element that includes various processing defects.

FIG. 8D is a micrograph of an IMOD display element without the defects shown in FIG. 8C, according to various implementations.

FIG. 9 is a flow diagram illustrating an example manufacturing method for an IMOD display or display element, according to various implementations.

FIGS. 10A and 10B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations disclosed herein can be implemented to reduce image artifacts that are induced when excessive charge is injected into one or more layers of an IMOD display element. IMOD display elements can have an actuated state and an unactuated, or relaxed, state. As explained herein, the two conductive plates or layers of an IMOD display element may be actuated, or brought close to or proximate one another, when an actuation voltage is applied across the two conductive layers. Similarly, the display element may be unactuated, or relaxed, when a sufficiently low release voltage is applied across the conductive layers. When the display element is in the relaxed state, a gap is defined between the two conductive plates. When sunlight impinges on an IMOD display device, photons may be absorbed by one or more of the IMOD's layers for display elements in the actuated state. The absorbed photons may excite electrons within one or more of the conductive layer(s), and the excited electrons may be photoelectrically ejected from the conductive layer(s) of the display element, (for example, in a movable reflective layer) to a dielectric layer in the other layer of the display element (e.g., a stationary or fixed optical stack). The electrons injected into the other layer, such as a dielectric layer in the optical stack, may cause charge to build up in the optical stack. The charge build-up in the optical stack can cause a negative offset voltage shift, which can cause the actuation and/or release voltage for the display element to change. Thus, when the previously-calibrated actuation (or release) voltage is applied across the two conductive layers, the display element may not properly actuate (or release). Further, in some arrangements, the negative offset voltage shift can cause unintended actuation and/or unintended release. In general, therefore, the negative offset voltage shift caused by charge build-up in the optical stack can cause IMOD display elements to become uncalibrated and/or “out-of-tune” in some cases. The uncalibrated and out-of-tune display elements can cause undesirable image artifacts, such as stripes and/or dark regions in portions of the display. Accordingly, it can be desirable to reduce the image artifacts caused by charge injection into the optical stack.

In various implementations disclosed herein, a buffer layer can be applied to the movable reflective layer that can act to block charges from being ejected from the movable reflective layer into the optical stack. For example, a first dielectric layer can be applied over a first conductive layer of the optical stack. A movable reflective layer that is configured to actuate by moving proximate the movable stack can include a second conductive layer that is applied over a second dielectric layer (for example, the buffer layer) of the movable reflective layer. Thus, in some implementations, when the display element is in the actuated state, the first dielectric layer of the optical stack may be proximate the second dielectric layer (for example, the buffer layer) of the movable reflective layer. The second dielectric layer of the movable reflective layer may have a thickness that is selected such that, when the display element is in the actuated state, electrons that are photoelectrically ejected from the second conductive layer of the movable reflective layer are substantially prevented from being injected into the first dielectric layer of the optical stack. By substantially preventing such charge injection or migration, negative offset voltage shifts and undesirable image artifacts can be reduced. Those skilled in the art will appreciate that it is not necessary for the second dielectric layer to block injection of all photoelectrically ejected electrons in order to attain desirable improvements in image quality.

Thus, those skilled in the art will understand that determining whether a particular thickness of a buffer layer provides substantial prevention of injection of photoelectrically ejected electrons can be evaluated in various ways and/or using various metrics. As one example, the display elements can be physically examined using various microscopy techniques, such as scanning electron microscopy (SEM), transmission electron microscopy (TEM), x-ray photoelectron spectroscopy (XPS), etc. For example, these imaging techniques can be used to determine the type of material used in the buffer layer and/or the thickness of the buffer layer. In other examples, usage tests may be conducted to qualitatively determine how image artifacts arise over time when the display device is exposed to direct lighting conditions. In yet other examples, determining whether a particular thickness of a buffer layer provides substantial prevention of injection of photoelectrically ejected electrons can be evaluated by measuring offset voltage shifts. For example, in one implementation, if the offset voltage for a particular display element changes by less than or equal to a particular threshold amount after being exposed to light for a predetermined period of time, then it can be determined that the buffer layer is suitably thick to prevent charge injection. For example, in some arrangements, the predetermined period of exposure time can be in a range of about 100 hours to about 500 hours. In other arrangements, however, the predetermined period of exposure time can be less, such as about a day or two. For example, if the offset voltage shifts by less than or equal to about 1 volt over the predetermined time period, then it can be determined that the buffer layer is sufficiently thick. In another example, if the offset voltage shifts by less than or equal to about 0.6 volts over the predetermined time period, or alternatively by less than or equal to about 0.3 volts over the predetermined time period, then it can be determined that the buffer layer is sufficiently thick.

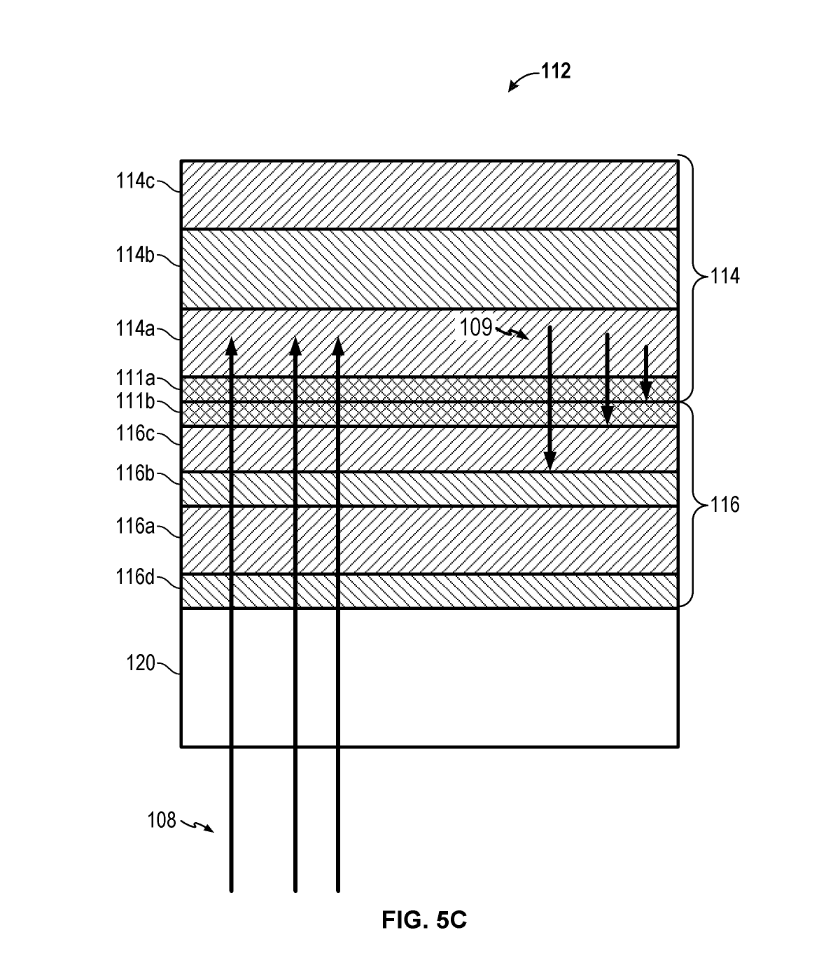

In other implementations, if the measured offset voltage for a particular display element is within a precalibrated voltage range after being exposed to sunlight for a particular period of time, then it can be determined that the buffer layer has a sufficient thickness to substantially prevent the injection of photoelectrically injected electrons. As explained herein with respect to FIG. 6, for example, for red display elements, if the measured offset voltage is in a range of about −0.75 V to about 0.75 V, or alternatively in a range of about −0.5 V to about 0.5 V, after being exposed to light for about 100 to about 300 hours, then it can be determined that a buffer layer is appropriately thick to prevent charge injection. For green display elements, if the measured offset voltage is in a range of about −0.3 V to about −0.6 V after being exposed to light for about 100 to about 300 hours then it can be determined that a buffer layer is appropriately thick to prevent charge injection. For blue display elements, if the measured offset voltage is in a range of about −0.75 V to about 0.75 V, or alternatively in a range of about −0.5 V to about 0.5 V after being exposed to light for about 100 to about 300 hours, then it can be determined that a buffer layer is appropriately thick to prevent charge injection. Although the time period mentioned herein has been described as in a range of about 100 to about 300 hours, it should be appreciated that this time period can be shorter, such as, for example, in a range of about 5 to about 10 hours. Further, in other arrangements, the offset voltage ranges for display elements of each color may be in a range of about −5V to 0V. Skilled artisans will appreciate that other ranges for offset voltages may be appropriate, depending on the particular display device, display element structure, drive waveform, and driver capability. It should be appreciated that there may be other ways to determine whether or not the buffer layer has an appropriate thickness to prevent charge injection into the optical stack. In alternative arrangements, for example, red, green, and blue display elements may be compared to the same range of precalibrated voltages, or to a particular target voltage. Furthermore, it should be appreciated that, as disclosed herein, other intervening layers may be applied in some implementations.

Thus, in various implementations disclosed herein, the thickness of the buffer layer can be selected to block charges from migrating from the movable reflective layer to the optical stack. In particular, the thickness of the buffer layer may be selected such that electrons in the second conductive layer of the movable reflective layer that are excited by photons within a particular energy range are substantially prevented from being injected into the optical stack. For example, the thickness of the buffer layer may be selected to block electrons excited by photons having energies in a range of about 1.6 eV to about 3.6 eV. In some arrangements, the thickness of the buffer layer may be in a range of about 50 Å to about 300 Å. For example, the thickness of the buffer layer may be in a range of about 80 Å to about 200 Å. Further, the thickness of the buffer layer may be in a range of about 90 Å to about 120 Å. The buffer layer can include any suitable dielectric material, such as, for example, silicon dioxide.

The thickness of the buffer layer can be further selected such that the actuation voltage (and/or the release voltage) is substantially independent of the thickness of the buffer layer. If the buffer layer is made to be too thick, for example, then the actuation voltage for the display element may increase, which may disrupt the driving scheme for the display. Thus, in some implementations, the thickness of the buffer layer is selected such that the buffer layer thickness remains in a regime where its thickness does not substantially affect the actuation and/or release voltages of the display element compared to the actuation and/or release voltages without the presence of the buffer layer.

In some implementations disclosed herein, a sacrificial material that is used to define an air gap of the display element may also be selected to reduce manufacturing costs and/or to improve device yield. For example, as explained in more detail herein, Molybdenum (Mo) is often used as a sacrificial material. Skilled artisans will appreciate that Mo is relatively expensive to apply using various processes. Furthermore, Mo may not be applied with a uniform thickness in some instances, which can cause a loss of device yield because the resulting air gap may have a varying height across the display element. As disclosed herein, amorphous silicon (α-Si) may instead be used as the sacrificial layer. In some implementations, for example, the α-Si sacrificial layer may be applied directly over a silicon dioxide (SiO₂) layer. Applying α-Si over a SiO₂ layer instead of over an aluminum oxide (Al₂O₃) layer may improve the adhesion of the sacrificial layer to the optical stack. Skilled artisans will appreciate that α-Si may be relatively inexpensive and can be applied to uniform thicknesses. Thus, by using α-Si as the sacrificial layer in some implementations disclosed herein, processing costs may be reduced and/or device yield may be increased.

Particular implementations of the subject matter described in this disclosure can be implemented to realize one or more of the following potential advantages. As explained herein, exposure to sunlight may cause charge injection into the optical stack. Adding a buffer layer to the movable reflective layer can prevent electrons from being ejected out of the movable reflective layer and into the optical stack when the display element is in the actuated state. Preventing such charge injection into the optical stack can reduce image artifacts associated with a negative offset voltage drift.

Implementations disclosed herein may also offer one or more processing improvements. For example, in some arrangements, applying the additional buffer layer to the movable reflective layer may reduce damage that can occur to the display element during processing. The buffer layer can prevent metal (for example, aluminum) from migrating from the movable reflective layer to an amorphous silicon sacrificial layer during high temperature processing. Such material migration can create particles and pits in portions of the display element. Furthermore, the use of the buffer layer can enable the use of amorphous silicon as the sacrificial layer instead of Molybdenum in some implementations, thereby reducing processing costs, and/or improving device yield.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

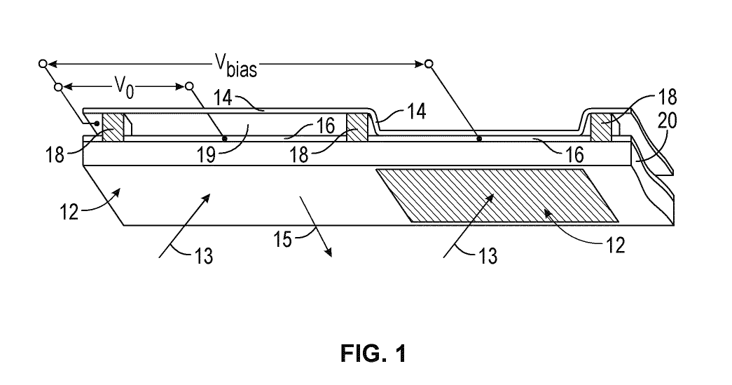

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

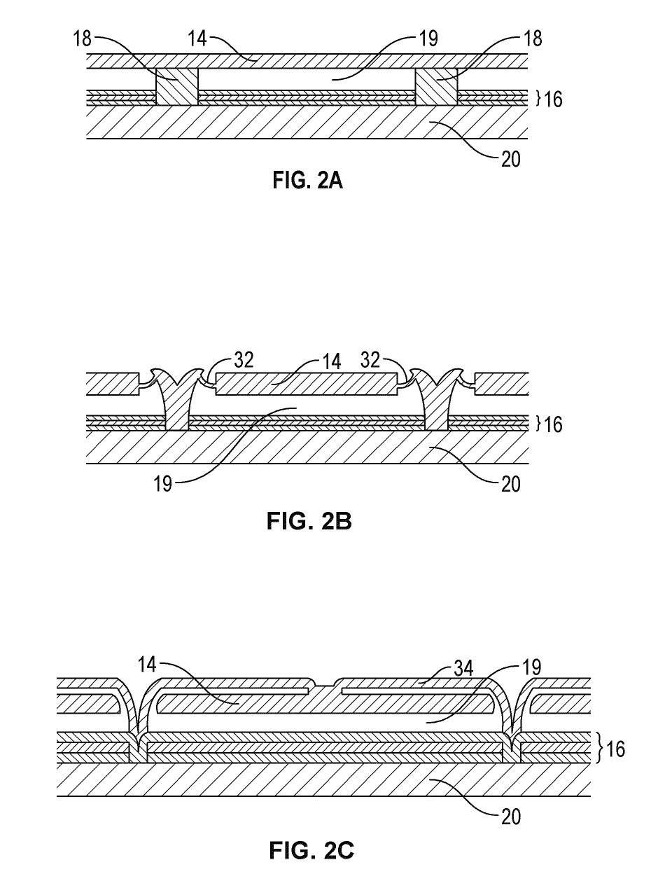

The details of the structure of IMOD displays and display elements may vary widely. FIGS. 2A-2E are cross-sectional illustrations of varying implementations of IMOD display elements. FIG. 2A is a cross-sectional illustration of an IMOD display element, where a strip of metal material is deposited on supports 18 extending generally orthogonally from the substrate 20 forming the movable reflective layer 14. In FIG. 2B, the movable reflective layer 14 of each IMOD display element is generally square or rectangular in shape and attached to supports at or near the corners, on tethers 32. In FIG. 2C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as implementations of “integrated” supports or support posts 18. The implementation shown in FIG. 2C has additional benefits deriving from the decoupling of the optical functions of the movable reflective layer 14 from its mechanical functions, the latter of which are carried out by the deformable layer 34. This decoupling allows the structural design and materials used for the movable reflective layer 14 and those used for the deformable layer 34 to be optimized independently of one another.

FIG. 2D is another cross-sectional illustration of an IMOD display element, where the movable reflective layer 14 includes a reflective sub-layer 14a. The movable reflective layer 14 rests on a support structure, such as support posts 18. The support posts 18 provide separation of the movable reflective layer 14 from the lower stationary electrode, which can be part of the optical stack 16 in the illustrated IMOD display element. For example, a gap 19 is formed between the movable reflective layer 14 and the optical stack 16, when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, for example, an aluminum (Al) alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 2D, some implementations also can include a black mask structure 23, or dark film layers. The black mask structure 23 can be formed in optically inactive regions (such as between display elements or under the support posts 18) to absorb ambient or stray light. The black mask structure 23 also can improve the optical properties of a display device by inhibiting light from being reflected from or transmitted through inactive portions of the display, thereby increasing the contrast ratio. Additionally, at least some portions of the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. In some implementations, the black mask structure 23 can be an etalon or interferometric stack structure. For example, in some implementations, the interferometric stack black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, tetrafluoromethane (or carbon tetrafluoride, CF₄) and/or oxygen (O₂) for the MoCr and SiO₂ layers and chlorine (Cl₂) and/or boron trichloride (BCl₃) for the aluminum alloy layer. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate electrodes (or conductors) in the optical stack 16 (such as the absorber layer 16a) from the conductive layers in the black mask structure 23.

FIG. 2E is another cross-sectional illustration of an IMOD display element, where the movable reflective layer 14 is self-supporting. While FIG. 2D illustrates support posts 18 that are structurally and/or materially distinct from the movable reflective layer 14, the implementation of FIG. 2E includes support posts that are integrated with the movable reflective layer 14. In such an implementation, the movable reflective layer 14 contacts the underlying optical stack 16 at multiple locations, and the curvature of the movable reflective layer 14 provides sufficient support that the movable reflective layer 14 returns to the unactuated position of FIG. 2E when the voltage across the IMOD display element is insufficient to cause actuation. In this way, the portion of the movable reflective layer 14 that curves or bends down to contact the substrate or optical stack 16 may be considered an “integrated” support post. One implementation of the optical stack 16, which may contain a plurality of several different layers, is shown here for clarity including an optical absorber 16a, and a dielectric 16b. In some implementations, the optical absorber 16a may serve both as a stationary electrode and as a partially reflective layer. In some implementations, the optical absorber 16a can be an order of magnitude thinner than the movable reflective layer 14. In some implementations, the optical absorber 16a is thinner than the reflective sub-layer 14a.

In implementations such as those shown in FIGS. 2A-2E, the IMOD display elements form a part of a direct-view device, in which images can be viewed from the front side of the transparent substrate 20, which in this example is the side opposite to that upon which the IMOD display elements are formed. In these implementations, the back portions of the device (that is, any portion of the display device behind the movable reflective layer 14, including, for example, the deformable layer 34 illustrated in FIG. 2C) can be configured and operated upon without impacting or negatively affecting the image quality of the display device, because the reflective layer 14 optically shields those portions of the device. For example, in some implementations a bus structure (not illustrated) can be included behind the movable reflective layer 14 that provides the ability to separate the optical properties of the modulator from the electromechanical properties of the modulator, such as voltage addressing and the movements that result from such addressing.

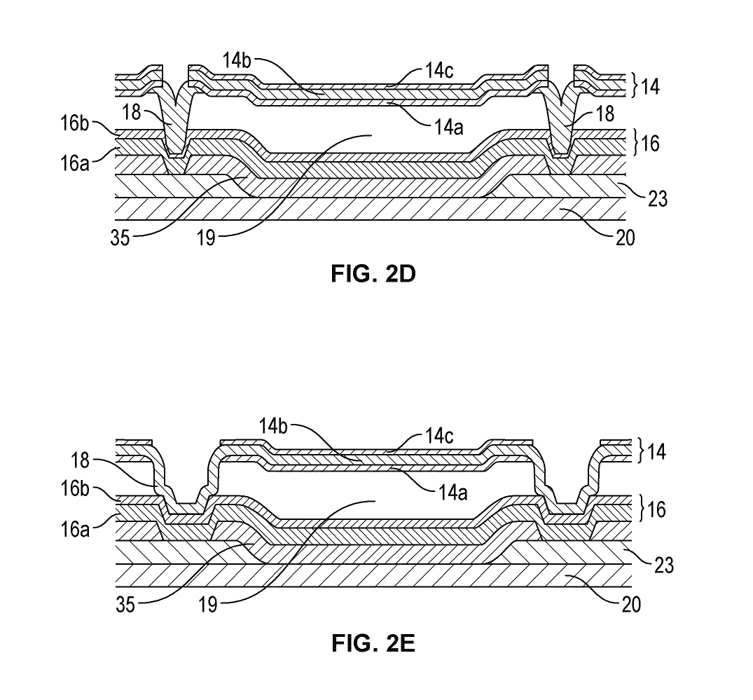

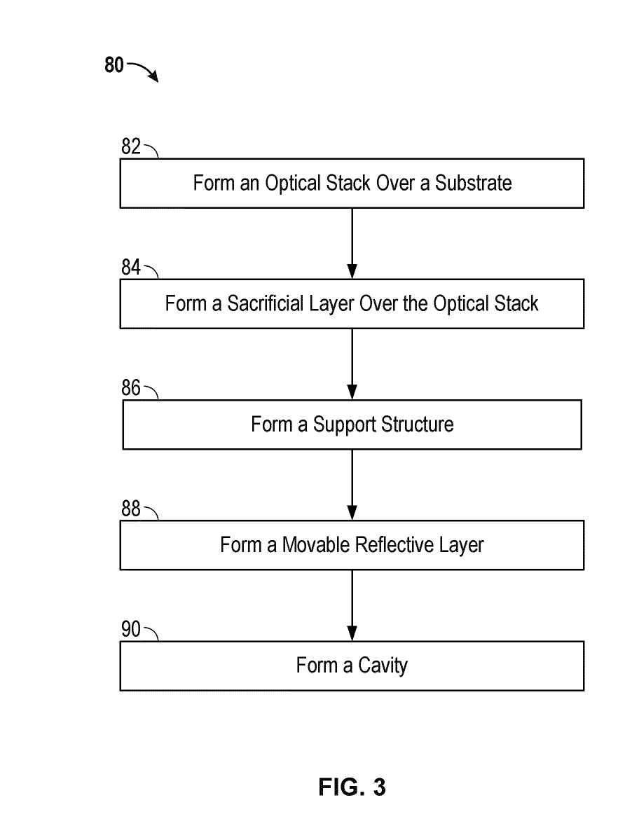

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (for example, relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. In various implementations disclosed herein, the use of amorphous silicon as the sacrificial material 25 can provide various processing advantages. For example, amorphous silicon is relatively inexpensive and can be applied to a relatively uniform thickness, as compared to using Mo as the sacrificial material 25. Furthermore, the application of a buffer layer between the movable reflective layer 14 and an amorphous silicon sacrificial layer 25 can prevent the migration of aluminum to the amorphous silicon sacrificial material 25, which can advantageously prevent visible pits and holes. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

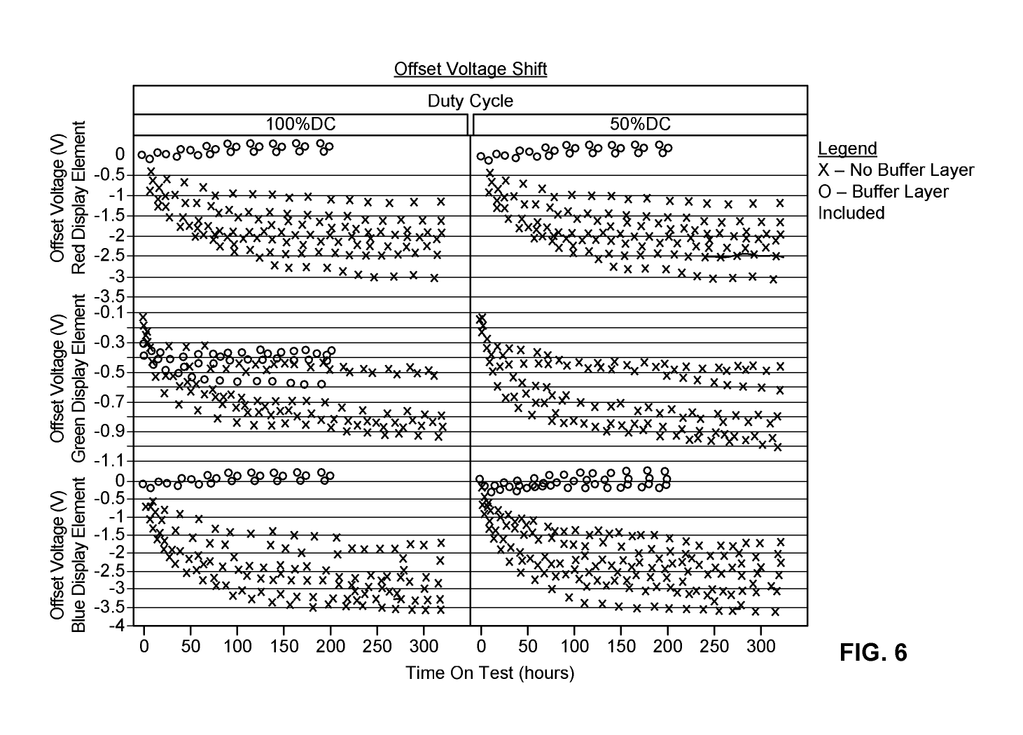

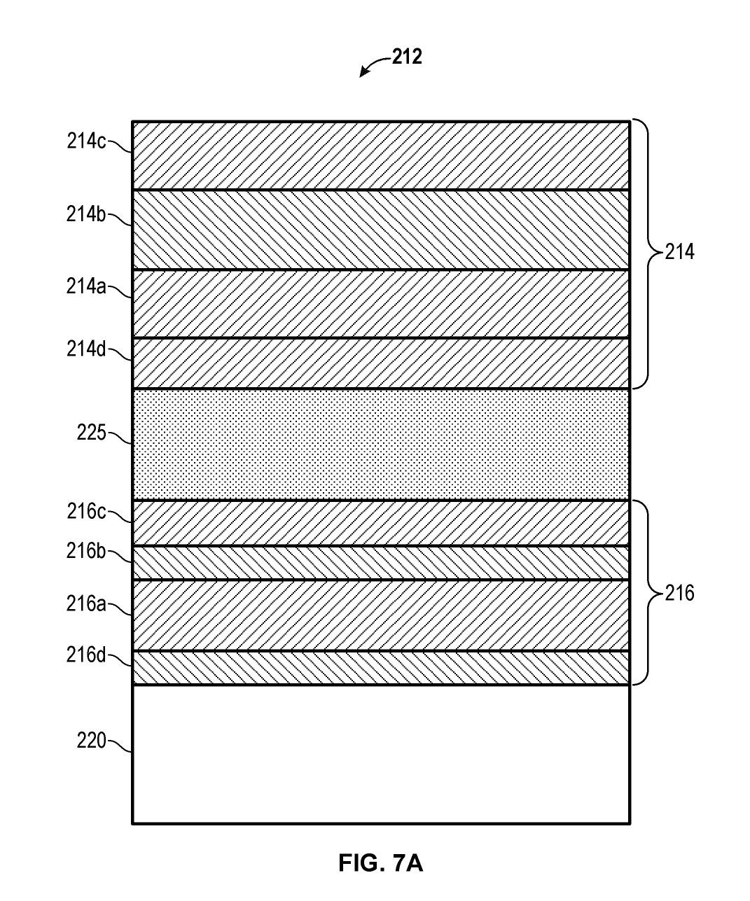

The process 80 continues at block 88 with the formation of a movable reflective layer or membrane such as the movable reflective layer 14 illustrated in FIG. 4D. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Furthermore, as explained herein with respect to FIG. 7A, for example, the movable reflective layer 14 can include a buffer layer positioned below the sub-layer 14a, i.e., between the sub-layer 14a and the sacrificial layer 25. As explained herein, the buffer layer (not shown in FIGS. 4A-4E) may advantageously prevent charge from being injected into the optical stack 16 as a result of exposure to sunlight. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. Various implementations disclosed herein may also utilize a buffer layer (for example, silicon dioxide) that can prevent metal migration (such as aluminum) from the movable reflective layer to an amorphous-Si sacrificial layer. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

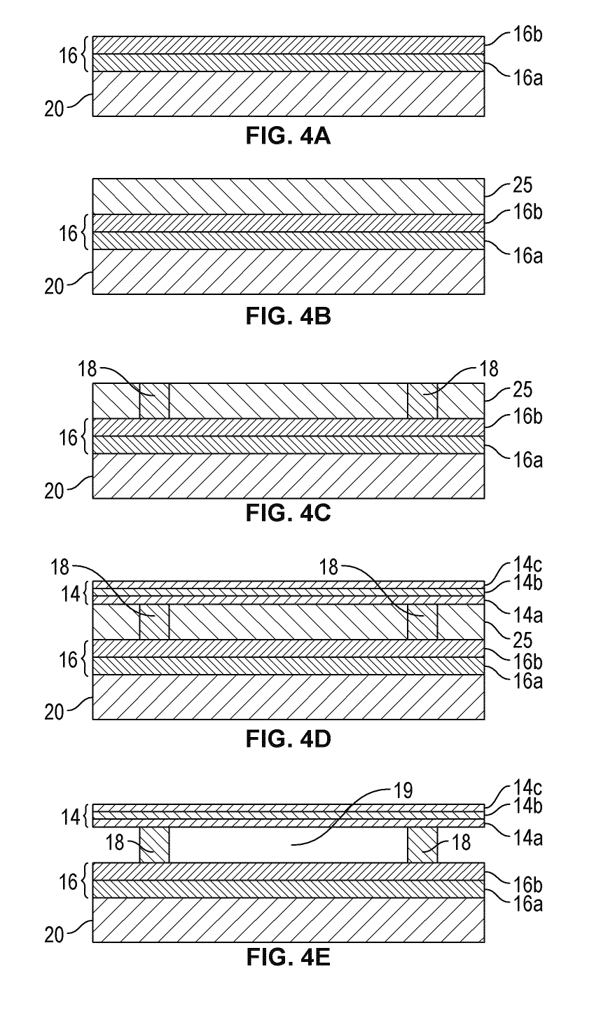

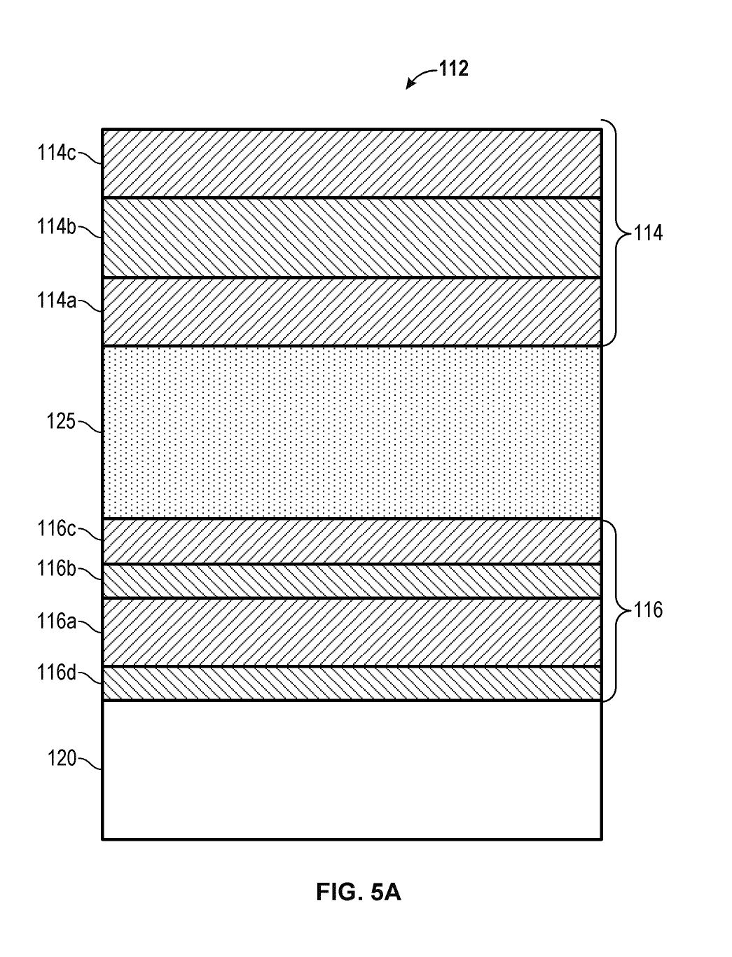

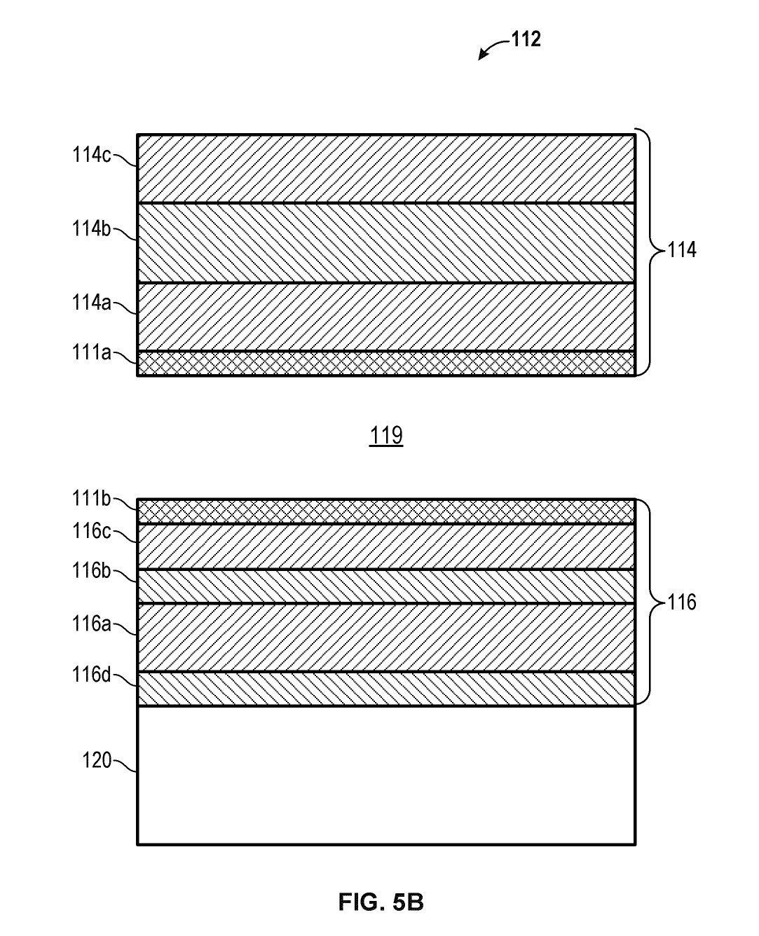

FIG. 5A is a schematic cross-sectional illustration of an unreleased IMOD display element 112, similar to the implementation illustrated in FIG. 4D. In the implementation illustrated in FIG. 5A, For example, FIG. 5A shows the display element 112 before the sacrificial material is selectively removed. Note that the illustrated layers are schematic and do not necessarily include all the details of a display element, such as the posts 18 described above. The illustrated layers are intended to give a general overview of the multi-layered display element according to various implementations. Further, as used herein, when one layer is described as being applied over another layer, it should be appreciated that the layer may be applied directly over the other layer, or one or more layers may intervene between the applied layer and the other layer. As with the display elements described above with respect to FIGS. 1 and 2A-2E, the display element 112 of FIG. 5A can include a movable reflective layer 114 and an optical stack 116. During processing, a sacrificial layer 125 may be applied between the optical stack 116 and the movable reflective layer 114.

The optical stack 116 may be applied over a transparent substrate 120, similar to the substrate 20 described herein. The optical stack 116 may be similar to the optical stack 16 described above with respect to FIGS. 1 and 2A-2E, except the optical stack 116 shown in FIG. 5A illustrates the inclusion of additional layers. For example, as explained above, the optical stack 116 can include a conductive optical absorber layer 116a that may serve as a stationary electrode and as a partially reflective layer or as a partially absorbing layer. The optical absorber layer 116a may be any suitable conductor; however, in the implementation of FIG. 5A, the optical absorber layer 116a includes molybdenum-chromium (MoCr).

Unlike the implementation of FIGS. 2A-2E, however, the optical stack 116 can include multiple dielectric layers in some arrangements, rather than the single dielectric layer 16b shown with respect to FIGS. 2A-2E. For example, an optional base dielectric 116d can be applied over the transparent substrate 120, and the conductive absorber layer 116a may be applied over the optional base dielectric 116d. The optional base dielectric 116d can be any suitable dielectric material, such as an oxide (e.g., silicon dioxide or silicon oxynitride). In some arrangements, the base dielectric 116d can act as a barrier between the substrate 120 and the remainder of the device, and/or the base dielectric 116d can improve the optical response of the display element 112. In other implementations, however, the base dielectric 116d is not included in the optical stack 116.

Further, a first dielectric sub-layer 116b may be applied over the optical absorber layer 116a, and a second dielectric sub-layer 116c may be applied over the first dielectric sub-layer 116b, as shown in FIG. 5A. The first and second dielectric sub-layers 116b and 116c may be any suitable dielectric material. However, in the implementation illustrated in FIG. 5A, the first dielectric sub-layer 116b may be a silicon dioxide layer (SiO₂), and the second dielectric sub-layer 116c may be an aluminum oxide layer (Al₂O₃). In various arrangements, the first and second dielectric sub-layers 116b and 116c may be applied using plasma-enhanced chemical vapor deposition processes (PECVD) or physical vapor deposition (PVD) processes. For example, the first dielectric sub-layer 116b may be applied over the conductive absorber layer 116a using a PECVD process, and the second dielectric sub-layer 116c may be applied using a PVD process, or vice versa. Although two sub-layers 116b and 116c are shown in FIG. 5A, it should be appreciated that the implementations disclosed herein may also be used when only one dielectric layer is applied over the absorber layer 116a in the optical stack 116 (as in FIGS. 2A-2E). The sub-layers of the optical stack 116 can be any suitable thickness. In some implementations, for example, the thicknesses of the sub-layers 116b and 116c can be in a range of about 100 Å to about 300 Å. For example, the thicknesses of the first dielectric sub-layer 116b can be in a range of about 200 Å to about 300 Å in some arrangements. In various implementations, the thicknesses of the second dielectric sub-layer 116c can be in a range of about 100 Å to about 200 Å. Furthermore, the thickness of the conductive absorber layer 116a can be any suitable thickness. For example, the thickness of the conductive absorber layer 116a can be in a range of about 30 Å to about 70 Å; in one implementation, the thickness of the absorber layer 116a can be about 50 Å. Other thicknesses for the sub-layers of the optical stack 116 may be suitable.

The sacrificial layer 125 may be applied over the second dielectric sub-layer 116c. In various arrangements, the sacrificial layer 125 is molybdenum (Mo) or amorphous silicon, although other sacrificial materials may be used. As explained herein, when the sacrificial layer 125 is selectively removed, an air gap is formed between the optical stack 116 and the movable reflective layer 114. Further, as explained above, Al₂O₃ can be used in the optical stack 116 as the second dielectric sub-layer 116c. The Al₂O₃ sub-layer 116c may act as an etch stop when Mo is used as the sacrificial material 125.

The movable reflective layer 114 can include a reflective layer 114a, a support layer 114b, and a conductive layer 114c, which may be configured to serve as an electrode. As shown in FIG. 5A, the reflective layer 114a may be applied over the sacrificial layer 125, the support layer 114b may be applied over the reflective layer 114a, and the conductive layer 114c may be applied over the support layer 114b. The layers 114a-c of the movable reflective layer 114 may be generally similar to the layers 14a-c of the layer 14 described above with respect to FIGS. 2A-2E. For example, the reflective layer 114a may serve to reflect light incident on the display. The reflective layer 114a may include aluminum-copper (AlCu), for example, an aluminum (Al) alloy with about 0.5% copper (Cu), or another reflective metallic material. The support layer 114b may provide support for the movable reflective layer 114. In some implementations, the support layer 114b may include one or more layers of a dielectric material, for example, silicon oxynitride (SiON) or silicon dioxide (SiO₂). In some implementations, the support layer 114b can be a stack of layers, such as, for example, a SiO₂/SiON/SiO₂ tri-layer stack. The conductive layer 114c may serve as an electrode and can be any suitable conductor, such as, e.g., aluminum or an aluminum alloy.

FIG. 5B is a schematic cross-sectional illustration of a released IMOD display element 112 in a relaxed state. Unless otherwise noted, the components shown in FIG. 5B may be the same as or similar to the components described above with respect to FIG. 5A. When the sacrificial layer 125 of FIG. 5A is selectively removed after processing (for example, etched), a gap 119 may be defined between the movable reflective layer 114 and the optical stack 116 when the display element 112 is in the relaxed state. For example, XeF₂ gas may be used to remove the sacrificial layer 125. As explained herein, the thickness of the sacrificial material 125 can determine the height of the gap 119. Also, although not shown in FIG. 5B, support posts (like the posts 18 described above) may be used to provide standoff between the movable reflective layer 114 and the optical stack 116.

In some implementations, when the display element 112 is actuated, the second dielectric sub-layer 116c may stick to the reflective layer 114a when a release voltage is subsequently applied. Such stiction may affect the display quality of the IMOD display. To reduce stiction, a first interface dielectric 111a may be applied over the outer or bottom surface of the reflective layer 114a of the movable reflective layer 114. Similarly, a second interface dielectric 111b may be applied over the outer or top surface of the second dielectric sub-layer 116c of the optical stack 116. Thus, as shown in FIG. 5B, when the first and second interface dielectrics 111a and 111b are applied, the optical stack 116 can further include the second interface dielectric 111b, and the movable reflective layer 114 can further include the first interface dielectric 111a.

The first and second interface dielectrics 111a and 111b may be formed to be very thin in some arrangements so as not to affect the actuation and/or release voltages of the display element 112. In some implementations, the first and second interface dielectrics 111a and 111b may be applied after the display element 112 is released, for example, after selectively removing the sacrificial material 125. For example, apertures in the display element 112 may be provided that allow an atomic layer deposition (ALD) process to be performed. In some implementations, therefore, an ALD process may be used after release to deposit aluminum oxide as the first and second interface dielectrics 111a and 111b. For example, in some arrangements, each of the first and second interface dielectrics may independently have a thickness in a range of about 10 Å to about 500 Å. More particularly, each of the first and second interface dielectrics may independently have a thickness in a range of about 20 Å to about 150 Å. Other suitable dielectrics may be used to prevent stiction. Furthermore, while the interface dielectrics 111a and 111b are described as being deposited using ALD, it should be appreciated that any other suitable method may be used, including methods that apply the interface dielectrics 111a and 111b before the sacrificial material 125 is removed.

FIG. 5C is a schematic cross-sectional illustration of a released IMOD display element 112 in an actuated state. The display element 112 of FIG. 5C may be similar to or the same as the display element 112 of FIGS. 5A-5B. As explained herein, when a sufficiently high actuation voltage is applied across the optical stack 116 and the movable reflective layer 114, the display element 112 may actuate to the actuated state. For example, as shown in FIG. 5C, when the actuation voltage is applied, the movable reflective layer 114 is moved to be closer to, or in contact with, the optical stack 116. Thus, when the display element 112 is actuated, the first interface dielectric 111a and the reflective layer 114a are moved to be proximate the second interface dielectric 111b and the second dielectric sub-layer 116c.

As explained above, when an IMOD display is used in bright lighting conditions, such as under direct sunlight, photons can pass through the optical stack 116 and can impinge on the movable reflective layer 114. For example, as shown in FIG. 5C, the photons 108 can impinge on the reflective layer 114a. Photons 108 impinging on the reflective layer 114a may be absorbed or reflected by the reflective layer 114a and may excite electrons 109 within the reflective layer 114a by imparting energy to the free electrons within the metal. The excited electrons 109 within the reflective layer 114a may be photoelectrically ejected from the reflective layer 114a and migrate or be injected into the optical stack 116 if the incident photons 108 are at an appropriate energy.

In some arrangements, a filter (not illustrated in FIG. 5) applied over the outside of the display may remove a wide band of infrared and/or ultraviolet light before it reaches the display element 112. However, in various implementations, the filter may not be configured to filter light with photon energies in a range of about 1.6 eV to about 3.6 eV. Photons 108 within this band of energies may excite electrons 109 with energies in the conduction band of the first and second interface dielectrics 111a and 111b. For example, the interface between the reflective layer 114a and the first interface dielectric 111a may have an approximately 2.1 eV barrier height, such as, for example, when the reflective layer 114a includes aluminum-copper and when the first interface dielectric 111a includes ALD-applied aluminum-oxide. Thus, electrons 109 excited at energies greater than or equal to about 2.1 eV may be photoelectrically ejected from the reflective layer 114a through the first and second interface dielectrics 111a and 111b, and into the second dielectric sub-layer 116c, and possibly into the first dielectric sub-layer 116b. Indeed charge may be trapped at material interfaces, e.g., between the first interface dielectric 111a and the second dielectric 111b, between the second interface dielectric 111b and the second dielectric sub-layer 116c of the optical stack 116, and/or between the second dielectric sub-layer 116c and the first dielectric sub-layer 116b. Further, charge may also be trapped within the second dielectric sub-layer 116c and/or within the first dielectric sub-layer 116b. For example, when the first and/or second dielectric sub-layers include PVD-applied aluminum-oxide, charge may be trapped within these layers because of the layers' material properties. In other examples, however, charge may be trapped in other layers. Regardless of which layer traps the charges, the trapped charges may undesirably create a negative offset voltage as explained above. Furthermore, energetic electrons may be injected into the optical stack 116 when a voltage is applied to actuate the display element 112.

The charge that is trapped within the optical stack 116 (e.g., at interfaces in the stack 116, within the first and second dielectric sub-layers 116c and 116d, etc.) may induce a negative offset voltage shift. As explained above, this negative offset voltage shift may induce image artifacts when display elements are unintentionally actuated or released, or when the applied voltage (whether for actuation, hold, or release), does not properly actuate, hold, or release the display element. As explained herein, one way to mitigate the image artifacts that are induced when charge is injected into the optical stack 116 is to apply a buffer layer between the reflective layer 114a and the sacrificial layer 125 shown in FIG. 5A (as explained below with reference to FIG. 7). The buffer layer can act to prevent charge from being photoelectrically ejected out of the reflective layer 114a and into the optical stack 116.

FIG. 6 shows a set of graphs illustrating offset voltage shifts that may be induced when IMOD display elements are exposed to excessive amounts of sunlight. In particular, FIG. 6 shows six graphs that plot offset voltage over time for a 100% duty cycle and a 50% duty cycle for red, green, and blue display elements, respectively. As FIG. 6 illustrates, one way to determine whether there is a sufficient buffer layer thickness is to measure the offset voltages for a particular display element. As used herein, the offset voltage shifts may be measured relative to the initial offset voltage when the display device is first powered on, or to the initial offset voltage when the display device is powered on after having been previously powered off one or more times. As shown in FIG. 6, for display elements that do not include the applied buffer layer (represented by an “X” in FIG. 6), such as the display element 112 of FIGS. 5A-5C, the offset voltage for each of the red, green, and blue display elements may shift toward negative values over time as the display is subjected to direct sunlight. For example, red display elements can experience an offset voltage shift such that the offset voltage is in a range of about −1 V to about −3V. Green display elements can experience an offset voltage shift such that the offset voltage is in a range of about −0.5 V to about −1 V. Blue display elements can experience an offset voltage shift such that the offset voltage is in a range of about −1.5 V to about −3.5 V. For display elements without a sufficient buffer layer thickness, therefore, the illustrated shifts in the offset voltage for each display element can induce image artifacts when, for example, display elements are unintentionally actuated or released.

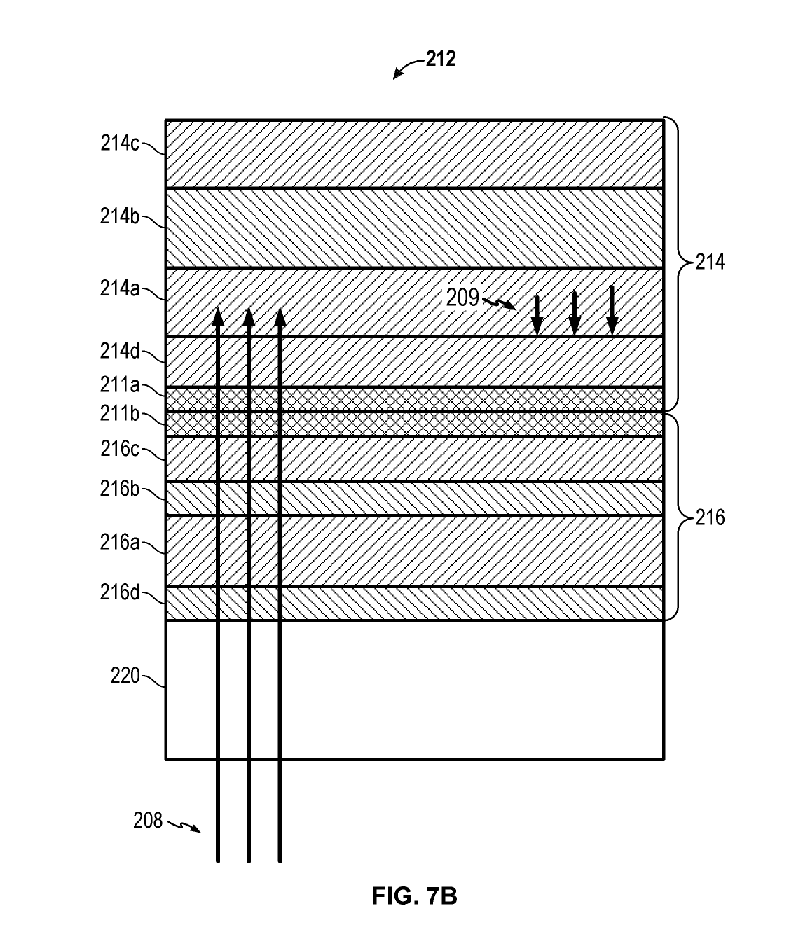

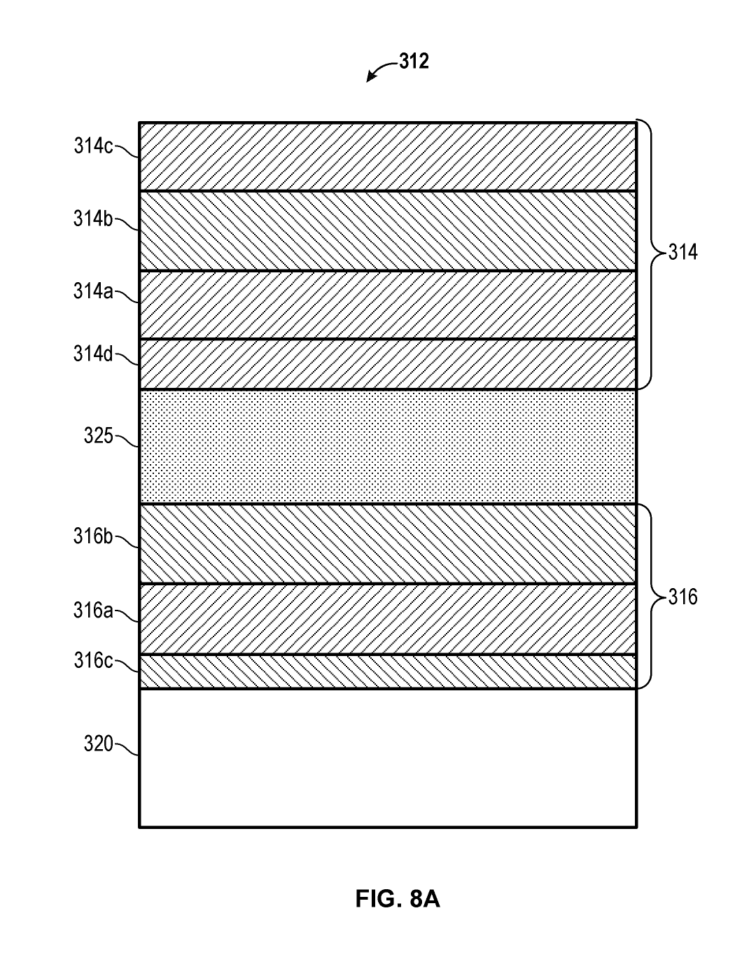

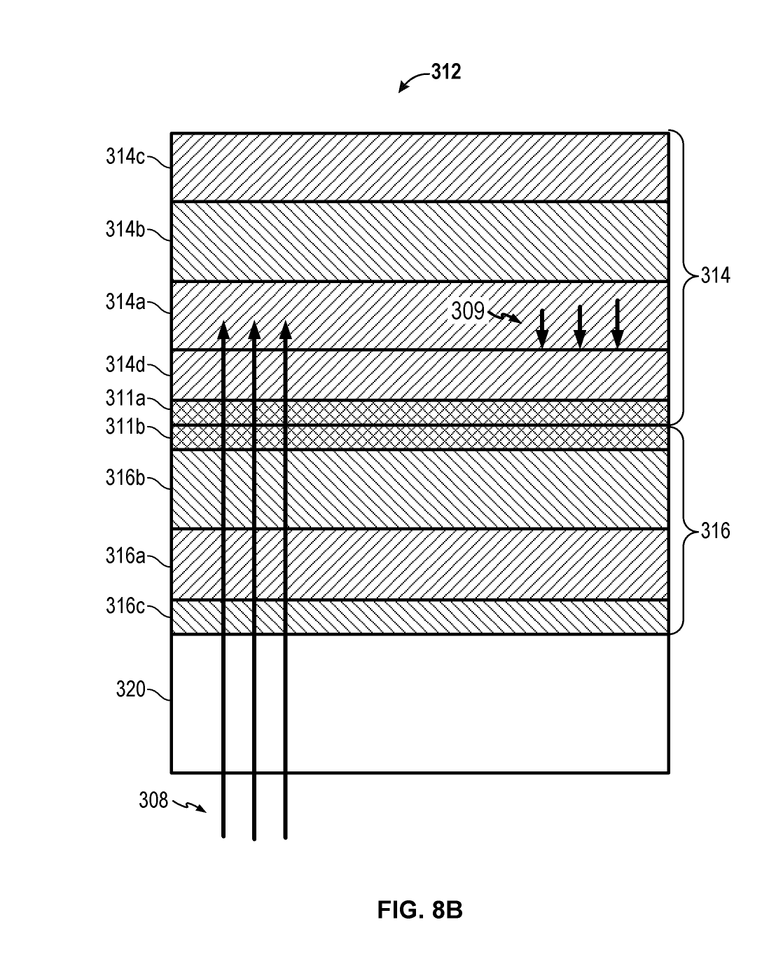

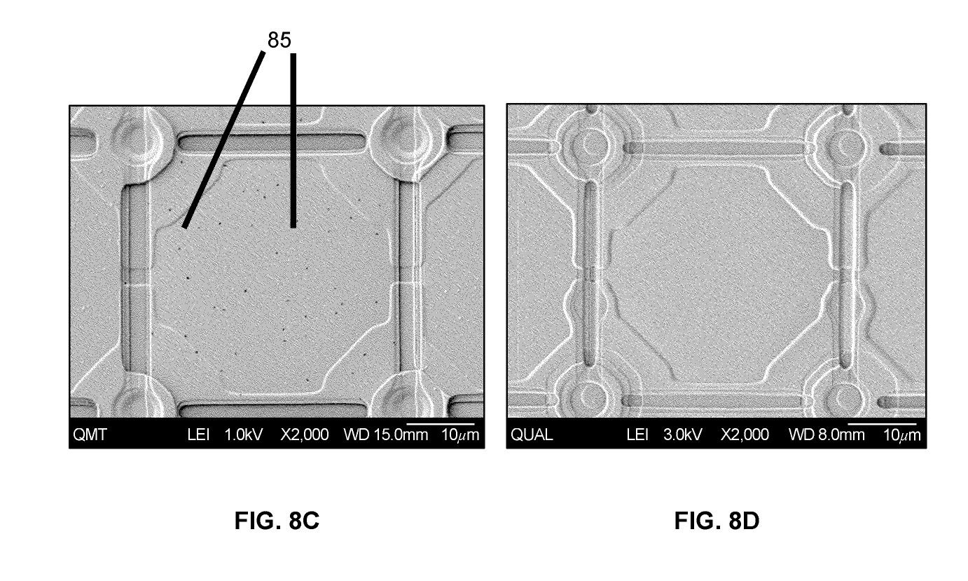

By contrast, when the buffer layer is included in the movable reflective layer 114 between the reflective layer 114a and the sacrificial layer 125 (see, for example, the buffer layer 214d between the reflective layer 214a and the sacrificial layer 225 of FIG. 7A below, and the buffer layer 314d of FIG. 8A below), the offset voltage does not substantially change, even when exposed to direct sunlight over an extended period of time. Including the buffer layer, as explained herein, can thereby lengthen the lifetime of IMOD display devices by substantially preventing charge from being photoelectrically ejected into the optical stack. Furthermore, as FIG. 6 illustrates, the offset voltages can be measured to determine whether a sufficient buffer layer thickness is applied in some implementations. For example, in FIG. 6, for the display elements with a suitable buffer layer, the offset voltage only drifted or changed by less than or equal to about 0.6 volts, or alternatively by less than or equal to about 0.3 volts, over a time period in the range of about 100 hours to about 1000 hours, measured relative to the initial offset voltage when the display device is first powered on, or to the initial offset voltage when the display device is powered on after having been previously powered off. In one particular example, the offset voltage may drift by less than or equal to about 0.3 volts in about 200 hours relative to the initial offset voltage.

FIG. 7A is a schematic cross-sectional illustration of an example unreleased IMOD display element 212, according to one implementation. Unless otherwise noted, the display element 212 can include the same or similar layers as the display element 112 shown in FIGS. 5A-5B. Like reference numerals generally refer to similar components. For example, in the unreleased IMOD display element 212 of FIG. 7A, an optical stack 216 may be applied over a transparent substrate 220. A sacrificial material 225 may be applied over the optical stack 216, and a movable reflective layer 214 may be applied over the sacrificial layer 225.

The optical stack 216 of FIG. 7A includes the same or similar layers as the optical stack 116 of FIG. 5A. For example, an optional base dielectric 216d may be applied over the transparent substrate 220. A conductive optical absorber layer 216a may be applied over the base dielectric layer 216d. As in FIG. 5A, a first dielectric sub-layer 216b may be applied over the optical absorber layer 216a, and a second dielectric sub-layer 216c may be applied over the first dielectric sub-layer 216b. The sacrificial layer 225 may similarly be applied over the second dielectric sub-layer 216c shown in FIG. 7A. As above, the sacrificial layer 225 may be selectively removed to form the air gap.

Unlike the implementation of FIG. 5A, however, the movable reflective layer 214 may include a buffer layer 214d applied over the sacrificial layer 225. The buffer layer 214d may be formed of silicon dioxide in some implementations. For example, silicon dioxide can be applied over the sacrificial layer 225 using a PECVD process to form the buffer layer 214d. In other arrangements, a PVD process can be used to apply the buffer layer 214d. It should be appreciated that any other suitable dielectric material may be used for the buffer layer, such as silicon oxynitride, silicon nitride, aluminum oxide, hafnium oxide, zirconium oxide, or other large band gap materials.

As shown in FIG. 7A, the reflective layer 214a may be applied over the buffer layer 214d. The support layer 214b may be applied over the reflective layer 214a, and the conductive layer 214c may be applied over the support layer 214b. The reflective layer 214a, the support layer 214b, and the conductive layer 214c may be the same as or similar to the reflective layer 114a, the support layer 114b, and the conductive layer 114c, respectively, described above with respect to FIGS. 5A-5C.

FIG. 7B is a schematic cross-sectional illustration of the IMOD display element 212 of FIG. 7A in a released and actuated state. Thus, the display element 212 of FIG. 7B is shown after the sacrificial material 225 is removed (for example, etched). As with the display element of FIGS. 5B and 5C, a first interface dielectric 211a and a second interface dielectric 211b may be applied to the movable reflective layer 214 and the optical stack 216, respectively. Indeed, as illustrated in FIGS. 5B and 5C, the second interface dielectric 211b may be applied over the outer or top surface of the second dielectric sub-layer 216c of the optical stack 216. Unlike in FIGS. 5B-5C, however, the first interface dielectric 211a may be applied over the outer or bottom surface of the buffer layer 214d. In some implementations, the first and second interface dielectrics 211a and 211b may be applied using an ALD process. For example, the first and second interface dielectrics 211a and 211b may include aluminum oxide. The first and second interface dielectrics 211a and 211b may prevent stiction when the display element 212 is in the actuated state.

As explained above with respect to FIG. 5C, photons 208 may pass through the optical stack 216 and the buffer layer 214d and may be absorbed in the reflective layer 214a of the movable reflective layer 214 as illustrated in FIG. 7B. As above, the photons 208 may excite electrons 209 within the reflective layer 214a of the movable reflective layer 214. However, as shown in FIG. 7B, the buffer layer 214d may be formed with a thickness that is selected such that, in the illustrated actuated state, electrons 209 that are photoelectrically ejected from the reflective layer 214a are blocked and thus substantially prevented from being injected into the first and second dielectric sub-layers 216b and 216c of the optical stack 216 (and/or the interfaces between the various dielectric layers as explained above). The buffer layer 214d may thereby block and/or trap electrons and prevent charge from being injected into the optical stack 216.

The buffer layer 214d may be sufficiently thick so as to block the excited electrons 209 from being injected into the optical stack 216. However, the thickness of the buffer layer 214d may be limited by the actuation and/or release voltages designed for a particular drive scheme. For example, it may be undesirable to use a buffer layer 214d that has a very large thickness. While a very large thickness may block electrons from being injected into the optical stack 216, an excessively thick buffer layer 214d may accordingly increase the actuation voltage to unacceptable levels for the driving scheme. Thus, the thickness of the buffer layer 214d may be selected to be thick enough to block electrons from being injected into the optical stack, yet thin enough such that the actuation voltage remains substantially unaffected. Thus, the thickness of the buffer layer 214d may be selected such that the thickness of the buffer layer 214d remains in a regime such that the actuation voltage (and/or release voltage) is substantially independent of changes in the thickness of the buffer layer 214d.

In some implementations, the thickness of the buffer layer 214d may be selected such that, in the actuated state, electrons 209 in the reflective layer 214a that are excited by photons 208 having energies in a range of about 1.6 eV to about 3.6 eV are substantially prevented from being injected into the optical stack 216, for example, into the first and/or second dielectric sub-layers 216b and/or 216c. For example, as explained above, the energy barrier height for the interface between the reflective layer 114a and the first and second interface dielectrics 111a and 111b without a buffer layer can be about 2.1 eV. When the buffer layer 214d is present below the reflective layer 214a as illustrated in FIG. 7B, however, the energy barrier may increase to, for example, about 3.1 eV. This heightened energy barrier can substantially block electrons 209 from being injected into the optical stack 216. In some implementations, for example, the buffer layer 214d may have a thickness in a range of about 50 Å to about 300 Å. In particular, the buffer layer 214d may have a thickness in a range of about 80 Å to about 200 Å. In further implementations, the buffer layer 214d may have a thickness in a range of about 90 Å to about 120 Å. As explained herein, the buffer layer 214d may include any suitable dielectric material, such as silicon dioxide. The above thickness ranges may also be effective in ensuring that the actuation and/or release voltages remain substantially unaffected by the buffer layer 214d.

FIG. 8A is a schematic cross-sectional illustration of an example unreleased IMOD display element 312, according to another implementation. Unless otherwise noted, the display element 312 can include the same or similar layers as the display element 212 shown in FIG. 7A. Like reference numerals generally refer to similar components, except where noted herein. For example, an optical stack 316 can be applied over a transparent substrate 320. A sacrificial material 325 can be applied over the optical stack 316, and a movable reflective layer 314 may be applied over the sacrificial material.

In the implementation of FIG. 7A, one sacrificial material 225 used to form the air gap is molybdenum (Mo). However, use of Mo may be relatively expensive, in part due to the large amount of XeF₂ gas that is used to remove the Mo. Furthermore, when Mo is deposited by PVD processes, the thickness of the Mo sacrificial material may be uneven, which can cause an uneven gap when the sacrificial material is removed. Accordingly, it can be advantageous to replace molybdenum as a sacrificial material.

In the implementation of FIG. 8A, therefore, amorphous silicon (α-Si) may instead be used as the sacrificial material 325. Compared with Mo, α-Si is relatively inexpensive and can be applied to a relatively uniform thickness. Thus, α-Si can reduce processing costs and/or increase device yield as compared to using Mo as the sacrificial material. As in FIG. 7A, an optional base dielectric 316c may be applied over the transparent substrate 320, and an optical absorber layer 316a may be applied over the base dielectric 316c.

However, unlike FIG. 7A, the implementation of FIG. 8A includes only a single dielectric layer 316b over the conductive optical absorber 316a within the optical stack 316. When α-Si is applied over aluminum oxide, Al₂O₃, (such as the second dielectric sub-layer 216c of FIG. 7A), the α-Si may delaminate from the aluminum oxide after PECVD deposition and/or after high temperature processing due to poor adhesion of α-Si on Al₂O₃. Thus, if the α-Si sacrificial layer 325 of FIG. 8A is applied directly over an aluminum oxide layer like the second dielectric sub-layer 216c of FIG. 7A, the α-Si may delaminate due to poor adhesion. Therefore, to improve the adhesion of the sacrificial layer 325 to the optical stack 316, the α-Si sacrificial layer 325 may instead be applied directly over the dielectric layer 316b. The dielectric layer 316b may be any suitable dielectric layer, such as a silicon dioxide layer.

As with FIG. 7A, the movable reflective layer 314 of FIG. 8A can include a buffer layer 314d applied over the sacrificial layer 325 and a reflective layer 314a applied over the buffer layer 314d. A support layer 314b may be applied over the reflective layer 314a, and a conductive layer 314c may be applied over the support layer 314b. The α-Si sacrificial layer 325 may be selectively removed by, for example, etching. For example, the dielectric layer 316b (and/or the buffer layer 314d) may act as an etch stop. In some implementations, a Cl₂/HBr/He—O₂ dry etch process may be used to etch the α-Si sacrificial material 325, and silicon dioxide can act as an etch stop.

FIG. 8B is a schematic cross-sectional illustration of the IMOD display element 312 of FIG. 8A in a released and actuated state. As with FIG. 7B, when photons 308 pass through the optical stack 316 and excite electrons 309 within the reflective layer 314a, the buffer layer 314d may be selected to block the electrons 309 from being photoelectrically ejected out of the reflective layer 314a and into the optical stack 316 (for example, the dielectric layer 316b). For example, the material and thickness of the buffer layer 314d may be selected as described above with respect to FIGS. 7A-7B. Further, a first interface dielectric 311a may be applied so as to be under the buffer layer 314d as illustrated in FIG. 8B, and a second interface dielectric 311b may be applied over the dielectric layer 316b. As above, the first and second interface dielectrics 311a and 311b may be applied using an ALD process after removing the sacrificial material 325. Although FIGS. 5B, 5C, 7B, and 8B depict IMOD display elements in either relaxed or actuated states, it is understood that the teachings herein also apply to multi-state IMOD display elements that may have a relaxed state, one or more intermediate actuated states where the air gap is controllably changeable to one or more heights or sizes, and an actuated or a fully actuated state. In some implementations of a multi-state IMOD display element, the IMOD display element may be controlled so that the movable reflective layer moves from the relaxed state to one or more “reverse actuated” states where the movable reflective layer is further away from the substrate in the one or more reverse actuated states than in the relaxed state. In some implementations a fully actuated state may be a white or a black state, while the relaxed and one or more intermediate actuated states includes colors such as, e.g., red, green, blue, cyan, yellow, magenta, etc. In some implementations a black state is one of the intermediate actuated states and the fully actuated state is a white state. Thus, in various implementations, the electromechanical display elements disclosed herein can have one or more intermediate actuated states between the relaxed state and a fully actuated state.

FIG. 8C shows a micrograph of an IMOD display element that includes various processing defects 85. In particular, when a display element is formed without the buffer layer 314d, metallic material, such as aluminum, may migrate from the reflective layer 314a to the α-Si sacrificial layer 325. For example, during high temperature processing (for example, greater than about 300° C.), the migrating metallic material may move into the α-Si sacrificial layer 325, which can create defects 85, such as particles and pits, on or in the dielectric layer 316b after removing the sacrificial layer 325. For example, the defects 85 can include metallic particles accumulated on the surface of these layers, and/or holes formed through these layers by the migrating metallic material. Accordingly, it can be desirable to reduce metallic material migration that may occur during high temperature processing.

FIG. 8D shows a micrograph of an IMOD display element without the defects shown in FIG. 8C, according to various implementations. In particular, FIG. 8D shows a display element that incorporates the buffer layer 314d as disclosed herein. The buffer layer 314d can act to block metallic material migration from the reflective layer 314a to the α-Si sacrificial layer 325, which may eliminate or substantially reduce particles and/or pits on the optical stack caused by aluminum migration after sacrificial layer release.

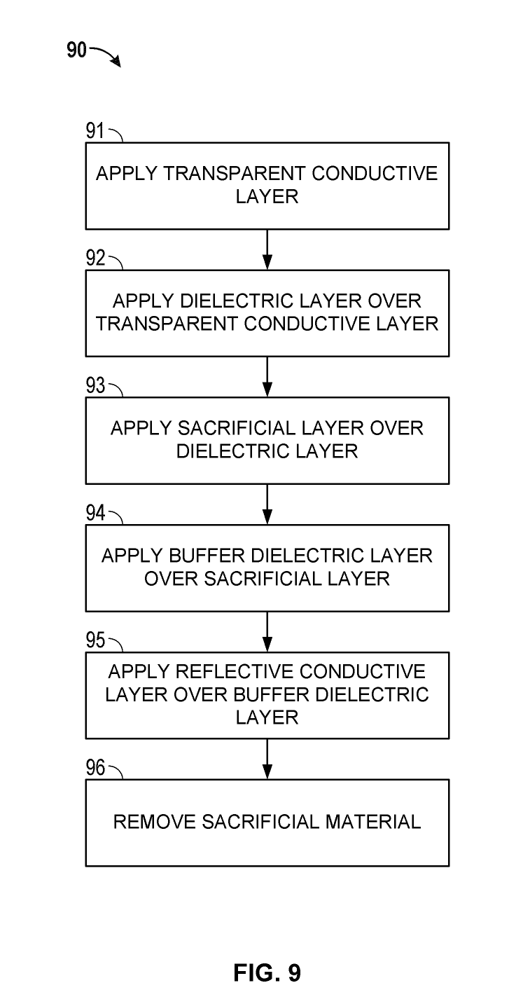

FIG. 9 is a flow diagram illustrating an example manufacturing method 90 for an IMOD display or display element, according to various implementations. The method 90 begins in a block 91 to apply a transparent conductive layer over a base layer. Although described as a “transparent” conductive layer, it is understood that the transparent conductive layer may be only semi-transparent. For example, in some implementations, the transparent conductive layer can be an optical absorber layer, and can therefore be partially absorptive. The optical absorber layer may be applied over an optional base dielectric or directly over a transparent substrate. In some implementations, the first conductive layer can include molybdenum-chromium.

The method 90 then proceeds to a block 92 to apply a dielectric layer over the transparent conductive layer. In various arrangements, at least one of a PVD and a PECVD process are performed to apply the dielectric layer. The dielectric layer can include one or more sub-layers, or the dielectric layer can be formed of a single material. For example, as explained herein with respect to FIGS. 7A-7B, the dielectric layer can include a first dielectric sub-layer applied over the transparent conductive layer, and a second dielectric sub-layer applied over the first dielectric sub-layer. The first dielectric sub-layer may include silicon dioxide, and the second dielectric sub-layer may include aluminum oxide, or vice versa. For example, a PVD (or PECVD) process may be used to apply silicon dioxide over the first conductive layer, and a PVD (or PECVD) process may be used to apply aluminum oxide over the silicon dioxide layer, or vice versa. Further, as explained herein with respect to FIGS. 8A-8B, the dielectric layer may include a single layer. In some implementations, for example, the dielectric layer can include silicon dioxide. As explained above, the thickness of the dielectric layer can be any suitable thickness. In some implementations, for example, the first dielectric sub-layer can have a thickness in a range of about 200 Å to about 300 Å. The second dielectric sub-layer can have a thickness in a range of about 100 Å to about 200 Å.

Turning to a block 93, a sacrificial material is applied over the dielectric layer. The sacrificial material may be applied and later removed (for example, at block 96) to form the air gap. The sacrificial material may be any suitable sacrificial material, such as molybdenum or amorphous silicon. When molybdenum is used as the sacrificial material, in some implementations, the molybdenum sacrificial material may be applied over an aluminum oxide layer. In other implementations, when amorphous silicon is used as the sacrificial material, the amorphous silicon sacrificial material may be applied over a silicon dioxide layer for improved adhesion.

The method 90 moves to a block 94 to apply a buffer dielectric layer over the sacrificial layer. The buffer dielectric layer can act as a buffer layer as described herein to prevent electrons from being photoelectrically ejected from the movable reflective layer to the optical stack. In some implementations, the buffer dielectric layer can include silicon dioxide, however, other dielectric materials may be suitable. The buffer dielectric layer may be applied by performing a PVD process and/or a PECVD process.

Turning to a block 95, a reflective conductive layer is applied over the buffer dielectric layer. In some implementations, the reflective conductive layer may act as the reflective layer of the movable reflective layer described herein. For example, the reflective conductive layer may include aluminum or aluminum-copper. In some implementations, the reflective conductive layer is not fully reflective, and may only be semi-reflective.

The method 90 moves to a block 96 to remove the sacrificial material to release the display element. As explained herein, an etching process (e.g., a wet etch, dry etch, plasma etch, etc.) may be performed to remove the sacrificial material. For example, Mo and α-Si sacrificial materials may be removed using an XeF₂ etch process. Skilled artisans will understand that various combinations of etchants and sacrificial materials may be suitable.

In some implementations, a first atomic deposition layer may be applied under the buffer dielectric layer, and a second atomic deposition layer may be applied over the dielectric layer. For example, the first and second atomic deposition layers may correspond to the first and second interface dielectrics described herein. In some implementations, the first and second atomic deposition layers may be applied after removing the sacrificial material. For example, an ALD process may be used to apply the first and second atomic deposition layers. In some implementations, the first and second atomic deposition layers may include aluminum oxide. Further, as explained herein, the buffer dielectric layer of the movable reflective layer may have a thickness that is selected such that, when the display element is in the actuated state, electrons that are photoelectrically ejected from the reflective conductive layer of the movable reflective layer are substantially prevented from being injected into the dielectric layer of the optical stack. It should be appreciated that, as disclosed herein, other intervening layers may be applied in some implementations. The first and second atomic deposition layers may be used to reduce stiction. Although the first and second atomic deposition layers are disclosed herein as being formed using an ALD process in some implementations, it should be appreciated that other processes may be used to form the first and second atomic deposition layers. For example, other types of processes may be used to create thin dielectric layers (such as the first and second interface dielectric layers described above) to prevent or reduce stiction.

Although the steps of the method 90 of FIG. 9 are illustrated in a particular order, it should be appreciated that other orders may be suitable. The illustrated orders are not intended to be limiting.

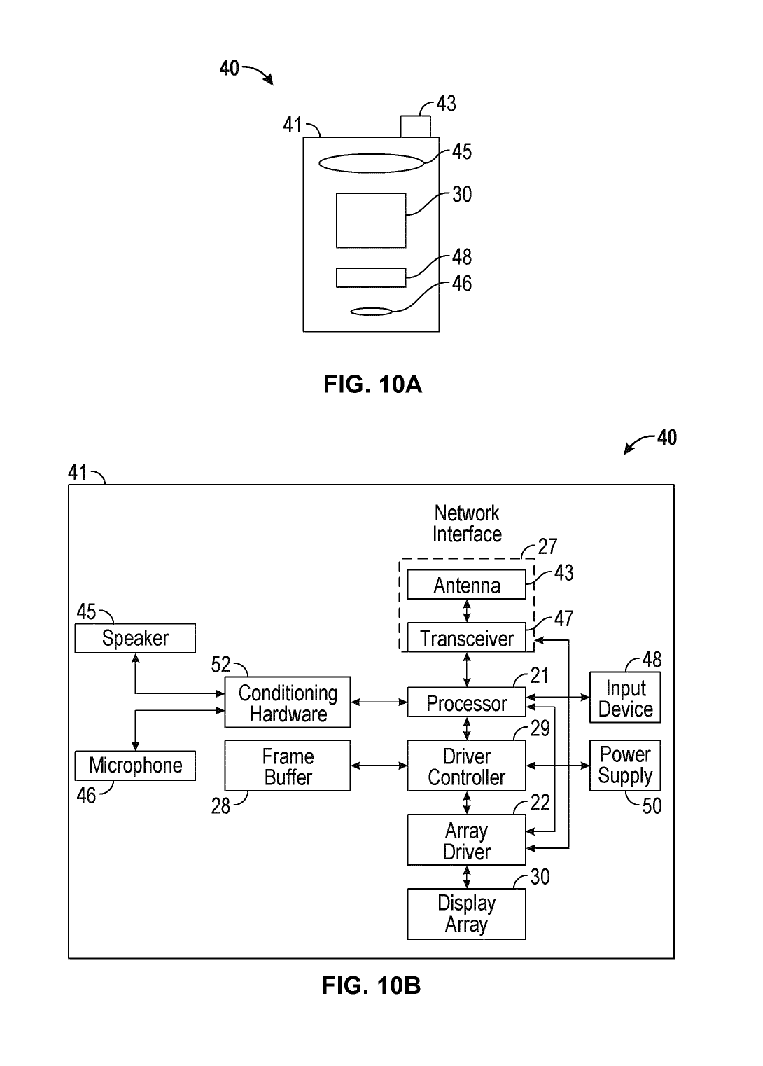

FIGS. 10A and 10B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein. For example, the display 30 can include a plurality of electromechanical display elements (for example, IMODs) that include a fixed optical element having a dielectric layer applied over a transparent or semi-transparent conductive layer. Each display element of the plurality of display elements can include a movable reflective element having a reflective conductive layer applied over a buffer dielectric layer. A gap can be defined by the dielectric layer and the buffer dielectric layer when the electromechanical display element is in the relaxed state, and the dielectric layer can be proximate the buffer dielectric layer when the electromechanical display element is in the actuated state. A thickness of the buffer dielectric layer can be selected such that, in the actuated state, electrons that are photoelectrically ejected from the reflective conductive layer are substantially prevented from being injected into the dielectric layer from the reflective conductive layer.

The components of the display device 40 are schematically illustrated in FIG. 10A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, for example, an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical display element having an actuated state and a relaxed state, the electromechanical display element comprising:
a fixed optical element having a dielectric layer applied over a transparent or semi-transparent conductive layer, and
a movable reflective element having a reflective conductive layer applied over a buffer dielectric layer;
wherein a gap is defined by the dielectric layer and the buffer dielectric layer when the electromechanical display element is in the relaxed state, and wherein the buffer dielectric layer is proximate the dielectric layer when the electromechanical display element is in the actuated state, and
wherein a thickness of the buffer dielectric layer is selected such that, in the actuated state, electrons that are photoelectrically ejected from the reflective conductive layer are substantially prevented from being injected into the dielectric layer.

2. The electromechanical display element of claim 1, wherein the buffer dielectric layer has a thickness in a range of about 50 Å to about 300 Å.

3. The electromechanical display element of claim 1, wherein the electromechanical display element is configured to actuate from the relaxed state to the actuated state when an actuation voltage is applied across the transparent or semi-transparent conductive layer and the reflective conductive layer, and wherein the thickness of the buffer dielectric layer is further selected such that the actuation voltage is substantially independent of the thickness of the buffer dielectric layer.

4. The electromechanical display element of claim 1, wherein the electromechanical display element includes one or more intermediate actuated states between the relaxed state and a fully actuated state.

5. The electromechanical display element of claim 1, wherein the thickness of the buffer dielectric layer is selected such that, in the actuated state, electrons in the reflective conductive layer that are excited by photons having energies in a range of about 1.6 eV to about 3.6 eV are substantially prevented from being injected into the dielectric layer from the reflective conductive layer.

6. The electromechanical display element of claim 1, wherein the thickness of the buffer dielectric layer is selected such that, after exposing the electromechanical display element to direct sunlight for about 100 hours after powering on the electromechanical display element, an offset voltage of the electromechanical display element shifts by less than or equal to about 0.5 volts.

7. The electromechanical display element of claim 6, wherein the thickness of the buffer dielectric layer is selected such that, after exposing the electromechanical display element to direct sunlight for about 200 hours after powering on the electromechanical display element, the offset voltage of the electromechanical display element shifts by less than or equal to about 0.3 volts.

8. The electromechanical display element of claim 2, wherein the thickness of the buffer dielectric layer is in a range of about 80 Å to about 200 Å.

9. The electromechanical display element of claim 2, wherein the thickness of the buffer dielectric layer is in a range of about 90 Å to about 120 Å.

10. The electromechanical display element of claim 1, wherein the buffer dielectric layer includes silicon dioxide (SiO₂).

11. The electromechanical display element of claim 10, wherein the buffer conductive layer includes aluminum (Al) or aluminum-copper (AlCu).

12. The electromechanical display element of claim 10, wherein the dielectric layer includes silicon dioxide (SiO₂) or aluminum oxide (Al₂O₃).

13. The electromechanical display element of claim 12, wherein the dielectric layer includes an SiO₂ layer and an Al₂O₃ layer.

14. The electromechanical display element of claim 12, wherein the transparent or semi-transparent conductive layer includes molybdenum-chromium (MoCr) or chromium (Cr).

15. The electromechanical display element of claim 1, further comprising a first atomic deposition layer applied under the buffer dielectric layer and a second atomic deposition layer applied over the dielectric layer.

16. The electromechanical display element of claim 15, wherein each of the first and second atomic deposition layers independently has a thickness in a range of about 10 Å to about 500 Å.

17. The electromechanical display element of claim 16, wherein each of the first and second atomic deposition layers independently has a thickness in a range of about 20 Å to about 150 Å.

18. The electromechanical display element of claim 17, wherein each of the first and second atomic deposition layers includes aluminum oxide (Al₂O₃).

19. A display apparatus comprising a plurality of electromechanical display elements, each electromechanical display element in the plurality comprising the electromechanical display element of claim 1.

20. The display apparatus of claim 19, further comprising:
a display including the plurality of electromechanical display elements;
a processor that is configured to communicate with the display, the processor being configured to process image data; and
a memory device that is configured to communicate with the processor.

21. The display apparatus of claim 20, further comprising:
a driver circuit configured to send at least one signal to the display; and
a controller configured to send at least a portion of the image data to the driver circuit.

22. The display apparatus of claim 20, further comprising an image source module configured to send the image data to the processor, wherein the image source module comprises at least one of a receiver, transceiver, and transmitter.

23. The display apparatus of claim 20, further comprising an input device configured to receive input data and to communicate the input data to the processor.

24. A method for manufacturing one or more electromechanical display elements having an actuated state and a relaxed state, the method comprising:
applying a transparent or semi-transparent conductive layer on a base layer;
applying a dielectric layer over the transparent or semi-transparent conductive layer;
applying a sacrificial layer over the dielectric layer;
applying a buffer dielectric layer over the sacrificial layer;
applying a reflective conductive layer over the buffer dielectric layer; and
removing the sacrificial material to define a gap between the dielectric layer and the buffer dielectric layer, and
wherein a thickness of the buffer dielectric layer is selected such that, upon actuation to move the buffer dielectric layer to be proximate the dielectric layer, electrons that are photoelectrically ejected from the reflective conductive layer are substantially prevented from being injected into the dielectric layer from the reflective conductive layer.

25. The method of claim 24, further comprising applying a first dielectric layer under the buffer dielectric layer and applying a second dielectric layer over the dielectric layer.

26. The method of claim 25, wherein applying the first dielectric layer and the second dielectric layer includes performing an atomic layer deposition process.

27. The method of claim 24, wherein applying the sacrificial layer includes applying amorphous silicon or molybdenum.

28. The method of claim 24, wherein applying the dielectric layer includes applying silicon dioxide (SiO₂) or aluminum oxide (Al₂O₃).

29. The method of claim 28, wherein applying the dielectric layer includes performing at least one of a physical vapor deposition (PVD) process and a plasma-enhanced chemical vapor deposition process (PECVD).

30. The method of claim 29, wherein applying the dielectric layer includes performing a PVD process to apply SiO₂ on the transparent or semi-transparent conductive layer.

31. The method of claim 30, wherein applying the dielectric layer further includes performing a PVD process to apply Al₂O₃ on the applied SiO₂ layer.

32. The method of claim 24, wherein applying the transparent or semi-transparent conductive layer includes applying molybdenum-chromium (MoCr).

33. The method of claim 24, wherein applying the buffer dielectric layer includes applying silicon dioxide (SiO₂).

34. The method of claim 33, wherein applying the buffer dielectric layer further includes performing at least one of a physical vapor deposition process and a plasma-enhanced chemical vapor deposition process.

35. The method of claim 24, wherein applying the reflective conductive layer includes applying aluminum (Al) or aluminum-copper (AlCu).

36. The method of claim 24, wherein applying the sacrificial layer includes applying the sacrificial layer over one or more layers that are applied over the dielectric layer.

37. A display apparatus comprising:
a plurality of electromechanical display elements, each electromechanical display element having an actuated state and a relaxed state and comprising:
a movable reflective element; and
a fixed optical element, wherein a gap is defined by the movable reflective element and the fixed optical element when the electromechanical display element is in the relaxed state, and wherein the movable reflective element is proximate the fixed optical element when the electromechanical display element is in the actuated state,
wherein the movable reflective element includes means for preventing electrons that are photoelectrically ejected from the movable reflective element from being injected into the fixed optical element when the electromechanical display element is in the actuated state.

38. The display apparatus of claim 37, wherein the preventing means prevent electrons in the movable reflective element that are excited by photons having energies in a range of about 1.6 eV to about 3.6 eV from being injected into the fixed optical element.

39. The display apparatus of claim 37, wherein the fixed optical element includes a dielectric layer applied over a transparent or semi-transparent conductive layer.

40. The display apparatus of claim 39, wherein the movable reflective element includes a reflective conductive layer applied over a buffer dielectric layer, and wherein the preventing means include the buffer dielectric layer.

41. The display apparatus of claim 40, wherein a gap is defined by the dielectric layer and the buffer dielectric layer when the electromechanical display element is in the relaxed state, and wherein the buffer dielectric layer is proximate the dielectric layer when the electromechanical display element is in the actuated state, and wherein a thickness of the buffer dielectric layer is selected such that, in the actuated state, electrons that are photoelectrically ejected from the reflective conductive layer are substantially prevented from being injected into the dielectric layer from the reflective conductive layer.

42. The display apparatus of claim 41, wherein the thickness of the buffer dielectric layer is in a range of about 80 Å to about 200 Å.

43. The display apparatus of claim 41, wherein the buffer dielectric layer includes silicon dioxide (SiO₂).

44. The display apparatus of claim 37, wherein the electromechanical display element includes one or more intermediate actuated states between the relaxed state and a fully actuated state.
